(19) United States
(12) Patent Application Publication
(10) Pub. No.: US 2014/0223801 A1
(43) Pub. Date: Aug. 14, 2014

(54) MOTORIZED SNARE

(71) Applicant: Christopher Dale McBride, Pleasant Grove, UT (US)

(72) Inventor: Christopher Dale McBride, Pleasant Grove, UT (US)

(21) Appl. No.: 14/173,632

(22) Filed: Feb. 5, 2014

Related U.S. Application Data
(60) Provisional application No. 61/762,862, filed on Feb. 9, 2013.

(51) Int. Cl. A01M 23/34

(52) U.S. Cl. CPC A01M 23/34
USPC 43/87

(57) ABSTRACT

Motorized snare. In one example embodiment, a motorized snare includes a housing, a snare cable extending from the housing and terminating in a noose, a retraction mechanism at least partially positioned within the housing and including a motorized reel attached to the snare cable, and a trigger mechanism configured, upon being triggered, to cause the motorized reel to reel in at least a portion of the snare cable into the housing.

### FIELD

The embodiments discussed herein are related to a motorized snare for trapping animals.

### BACKGROUND

Snares have been employed for centuries by trappers to trap animals to be used as a source of food and clothing.

FIG. 1 illustrates a first prior art snare 100. The snare 100 consists of a length of cordage 102 that is tied around something permanent, such as a tree 104, on one end and formed into a noose 106 on the other end. The noose 106 is positioned across an animal trail 108, or other place where an animal is likely to walk through. The noose 106 is generally positioned to hover over the ground at the height of the target animal's head so that as the animal walks along the animal trail 108, the animal's head passes through the noose 106. This positioning of the noose 106 can be accomplished using sticks 110. After the animal's head passes through the noose 106, the forward movement and subsequent struggling of the animal against the noose 106 will cause the noose 106 to tighten around the animal's neck. As long as the animal struggles against the noose 106, the noose 106 will remain tight around the animal's neck, thus trapping the animal.

FIG. 2 illustrates a second prior art snare 200. Similar to the snare 100, the snare 200 consists of a length of cordage 202 that is tied around something permanent, such as a tree 204, on one end and formed into a noose 206 on the other end. Also similar to the snare 100, the noose 206 is positioned across an animal trail 208, or other place where an animal is likely to walk through, and generally positioned hovering above the ground at the height of the target animal's head, using sticks 210, so that as the animal walks along the animal trail 208, the animal's head passes through the noose 206. Unlike the snare 100, however, the tree 204 to which the cordage 202 is tied is bent over so as to be spring loaded. The bend in the tree 204 is held in place with a notched stake 212 and a notched bar 214 that is tied to the cordage 202 between the noose 206 and the end of the cordage 202 that is tied to the tree 204. The notch in the notched bar 214 remains engaged with the notch in the stake 212 due to the upward spring tension 216 on the cordage 202 caused by the bend in the tree 204. After the animal's head passes through the noose 206, the forward movement and subsequent struggling of the animal against the snare 200 will cause the noose 206 to tighten around the animal's neck and will also cause the notched bar 214 to separate from the notched stake 212 due to the sideways tension 218 caused by the struggling animal. The separation of the notched bar 214 from the notched stake 212 will allow the tree 204 to spring back into its natural upright position, thus lifting the noose 206, and the animal ensnared therein, off the ground, thus maintaining the noose 206 tight around the animal's neck and lessening the likelihood that the animal will escape.

While the prior art snares 100 and 200 do occasionally trap an animal, they often allow potential animals to escape due to the animal simply walking around the snare or the animal not struggling enough to have the snare's noose tighten around the animal's neck. Also, in the case of the snare 200, the spring-loaded tree 204 often springs prematurely before an animal is properly positioned in the noose 206 or springs too slowly to catch the animal in the noose 206. Therefore, when the prior art snares 100 and 200 are relied up by a trapper to provide a source of food or clothing, the trapper often goes hungry and cold. The prior art snares 100 and 200 are also relatively difficult to set up properly.

Accordingly, there is a need in the art for a more reliable snare.

The subject matter claimed herein is not limited to embodiments that solve any disadvantages or that operate only in environments such as those described above. Rather, this background is only provided to illustrate one example technology area where some embodiments described herein may be practiced.

### SUMMARY

In general, example embodiments described herein relate to a motorized snare for trapping animals. At least some of the example motorized snares disclosed herein are more reliable, more versatile at trapping animals, and less difficult to set up properly than non-motorized prior art snares. Further, at least some of the example motorized snares disclosed herein can be activated more reliably and more quickly and with more force than non-motorized prior art snares. In addition, the relatively quick retraction of the noose of these example motorized snares may enable a larger noose to be set and/or enable a noose that does not need to come in contact with the animal prior to the motorized snare being triggered.

In one example embodiment, a motorized snare includes a housing, a snare cable extending from the housing and terminating in a noose, a retraction mechanism at least partially positioned within the housing and including a motorized reel attached to the snare cable, and a trigger mechanism configured, upon being triggered, to cause the motorized reel to reel in at least a portion of the snare cable into the housing.

It is to be understood that both the foregoing general description and the following detailed description are exemplary and explanatory and are not restrictive of the invention as claimed.

### BRIEF DESCRIPTION OF THE DRAWINGS

To further clarify certain aspects of the present invention, a more particular description of the invention will be rendered by reference to example embodiments thereof which are disclosed in the appended drawings. It is to be understood that the drawings are diagrammatic and schematic representations of such example embodiments, and are not limiting of the present invention, nor are they necessarily drawn to scale. Aspects of the invention will be described and explained with additional specificity and detail through the use of the accompanying drawings in which:

FIG. 1 illustrates a prior art snare;

FIG. 2 illustrates a second prior art snare;

FIG. 3A is a front top perspective view of an example motorized snare;

FIG. 3B is a corner top perspective view of the example motorized snare of FIG. 3A;

FIG. 3C is a rear top perspective view of the example motorized snare of FIG. 3A including an anchoring mechanism;

FIG. 3D is an enlarged perspective view of a portion of the example anchoring mechanism of the example motorized snare of FIG. 3C;

FIG. 3E is a front top perspective view of the example motorized snare of FIG. 3A with the lid open, which reveals an internal example trigger mechanism and an internal example refraction mechanism;

FIG. 4A is a top perspective view of the example trigger mechanism of FIG. 3E;

FIG. 4B is an enlarged perspective view of a trip switch of the example trigger mechanism of FIG. 4A with the trip switch untripped;

FIG. 4C is an enlarged perspective view of the trip switch of FIG. 4B with the trip switch tripped;

FIG. 5A is a top perspective view of the example refraction mechanism of FIG. 3E;

FIG. 5B is an enlarged perspective view of an extraction lock of the example retraction mechanism of FIG. 5A with the extraction lock engaged; and

FIG. 5C is an enlarged perspective view of the extraction lock of FIG. 5B with the extraction lock disengaged.

### DETAILED DESCRIPTION OF SOME EXAMPLE EMBODIMENTS

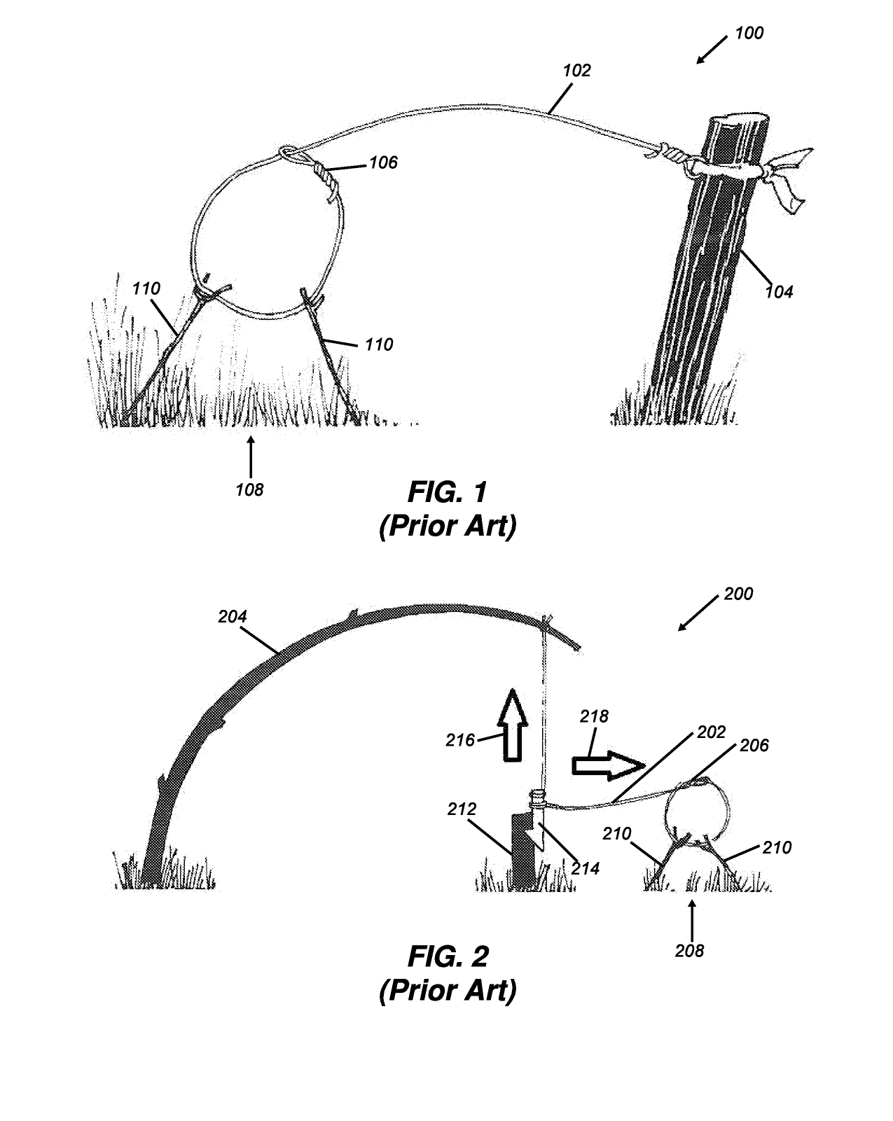

Example embodiments of the present invention relate to a motorized snare for trapping animals. The example motorized snare disclosed herein is more reliable and versatile at trapping animals than prior art snares 100 and 200 of FIGS. 1 and 2. The example motorized snare disclosed herein is also less difficult to set up properly than the prior art snares 100 and 200 of FIGS. 1 and 2.

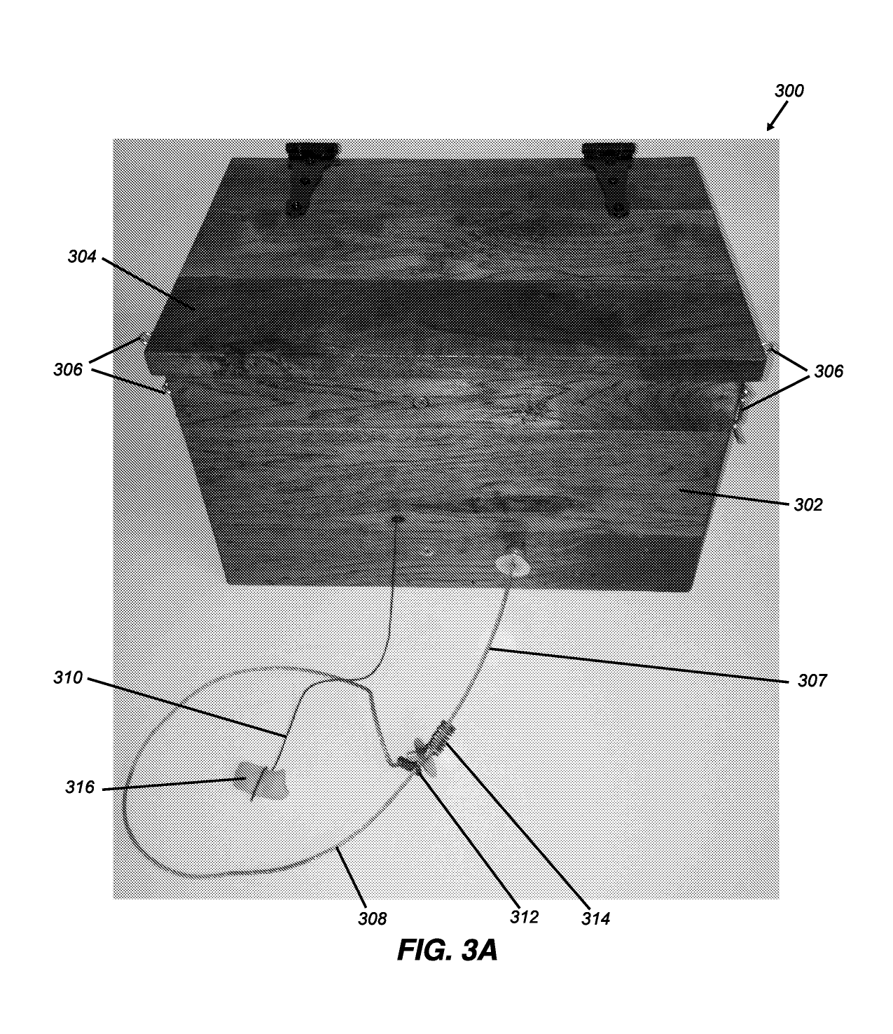

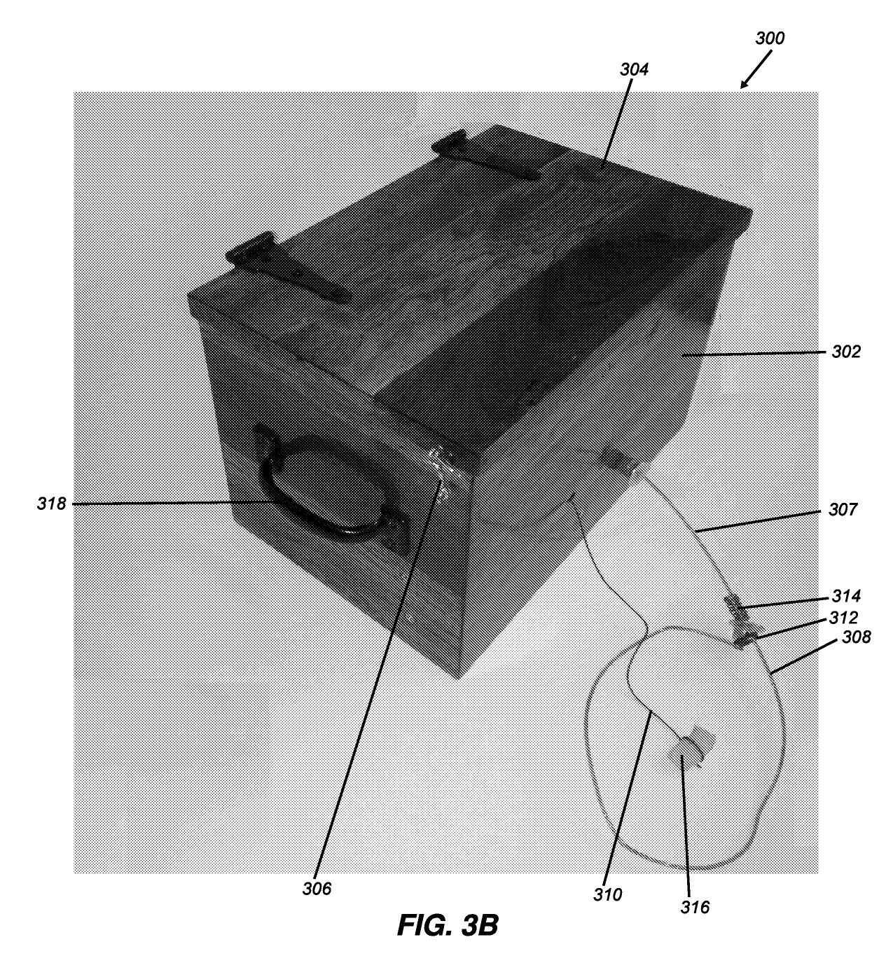

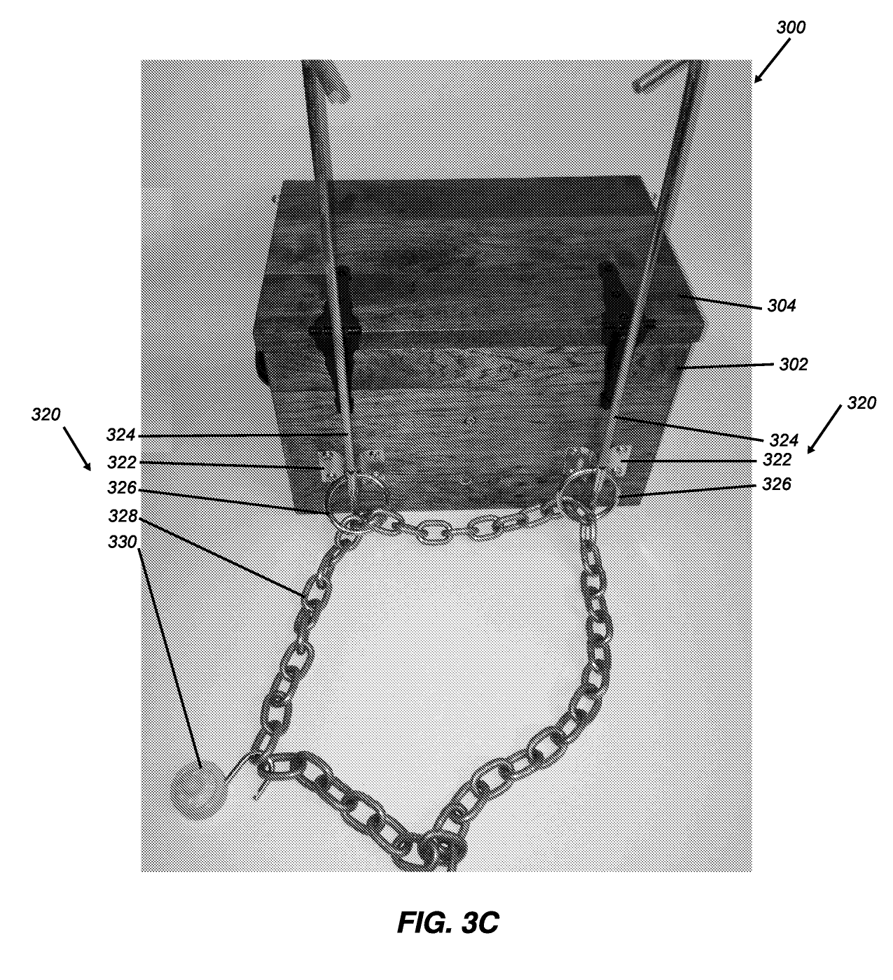

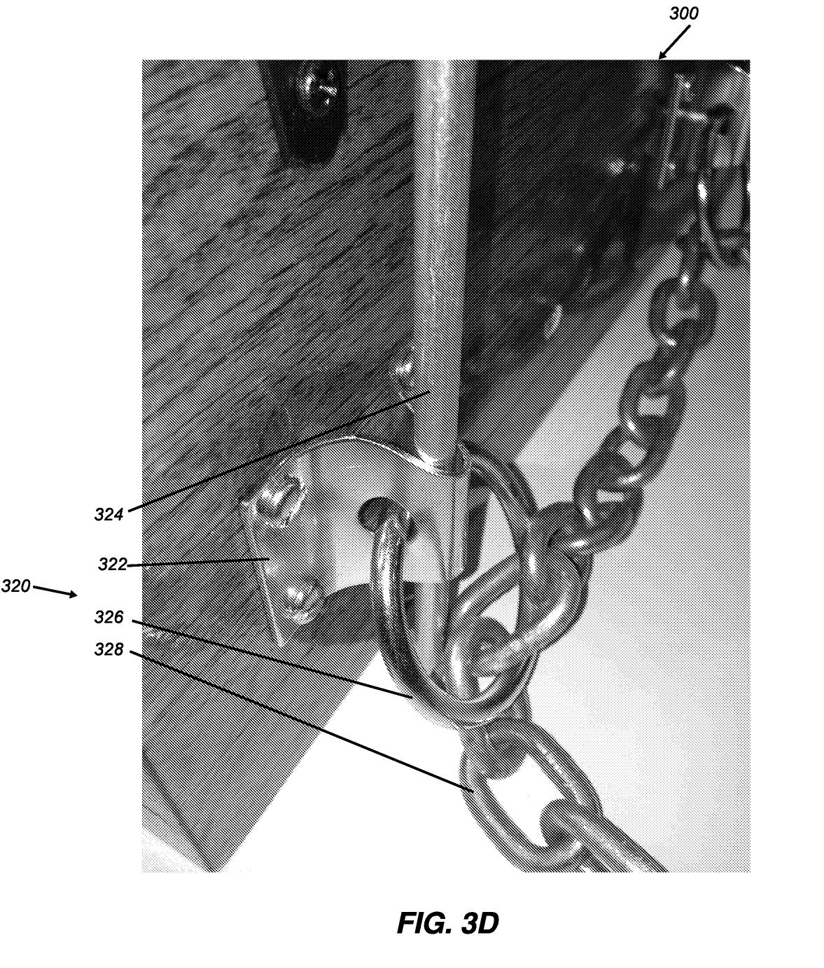

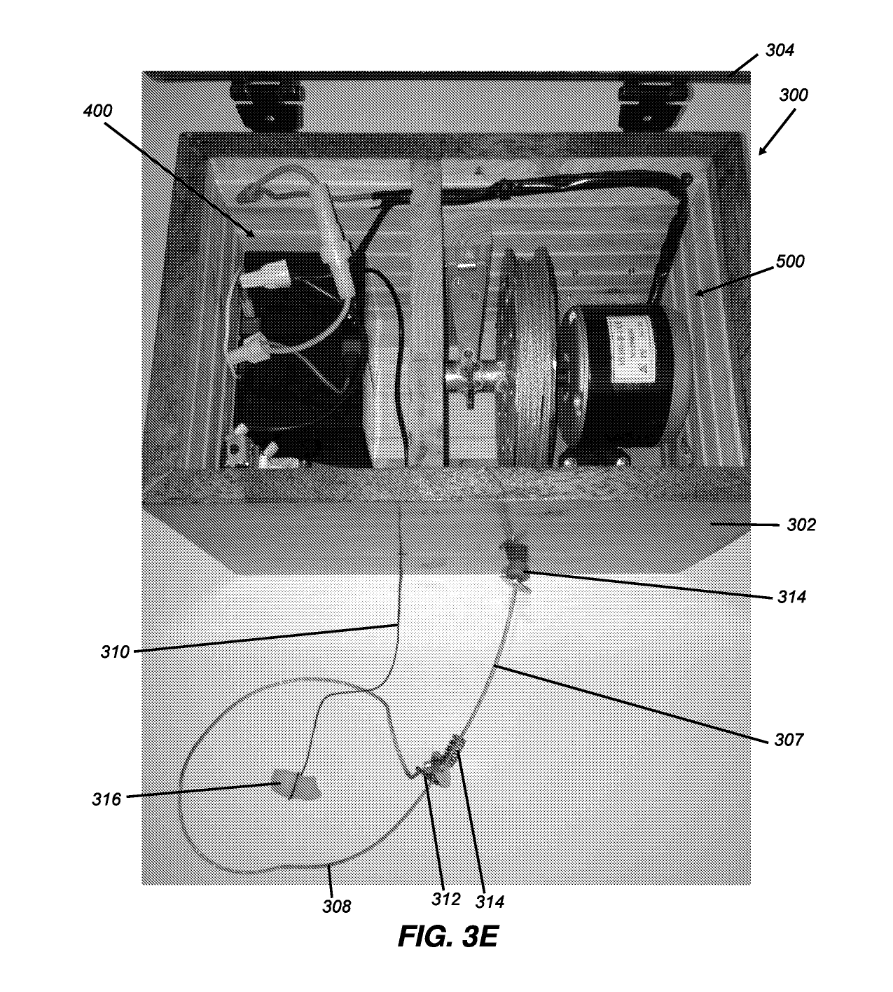

FIGS. 3A-3E are various perspective views of an example motorized snare 300. As disclosed in FIGS. 3A and 3B, the example motorized snare 300 generally includes a weatherproof housing 302 with a hinged lid 304 that allows access to the internal mechanisms of the motorized snare 300. The hinged lid 304 may include latches 306 to prevent an animal from inadvertently or intentionally opening the hinged lid 304 and thus exposing the internal mechanisms of the motorized snare to the elements. It is understood that the latched 306 may be replaced with one or more locking latches to further prevent humans from gaining access to the inside of the motorized snare. As disclosed in FIG. 3B, the motorized snare 300 may further include handles (only one of which is shown in FIG. 3B) to allow the motorized snare 300 to be conveniently carried by a trapper.

As disclosed in FIGS. 3C and 3D, the motorized snare 300 may further include an example anchoring mechanism 320. The anchoring mechanism 320 may include brackets 322 and stakes 324. The brackets 322 are attached to the housing 320 and hold the stakes 324, which may be driven deep into the ground to firmly anchor the housing 302 to the ground. Additionally or alternatively, the anchoring mechanism 320 may include rings 326, chain 328, and lock 330. The rings 326 are attached to the housing 302 by the brackets 322. The chain 328 may be threaded through the rings 326 and then wrapped around a permanent object, such as a tree trunk, and then locked with the lock 330 to securely anchor the housing 302 to the permanent object. Using either the stakes 324 or the chain 328, or both, the otherwise portable housing 302 can be fixed in place so that any animal trapped in the noose 308 (see FIGS. 3A, 3B, and 3E) cannot move the motorized snare 300 and/or so that a human cannot remove the motorized snare 300.

As disclosed in FIGS. 3A, 3B, and 3E, the motorized snare 300 may also include a snare cable 307, which terminates in a noose 308, and a trip line 310, both of which protrude from respective openings in the housing 302. The snare cable 307 may have any desired length and may be formed from a metal cable that is configured to break at a predetermined force, which may allow the noose 308 to successfully trap smaller animals that are not capable of exerting the breaking force while not trapping larger animals that are capable of exerting the breaking force. The snare cable 307 may also be configured to be interchangeable with different snare cables that are weaker or stronger than the snare cable 307, depending on the size of the targeted animal.

The noose 308 may include a cinch locking mechanism 312 that causes the noose 308 to remain tightly cinched around the neck, limb, torso, or combination thereof of a trapped animal, even where the animal and/or the motorized snare 300 has ceased to exert any pressure against the noose 308. The noose 308 may further include dampeners 314 that dampen the force of the noose 308 coming into contact with the housing 302 when the snare cable 307 is retracted into the housing 302, as discussed in greater detail below.

The trip line 310 may have any desired length and, unlike the snare cable 307, need not be heavy enough to retain a snared animal, and can thus be made from a very light line, such as common fishing line, to avoid detection by an animal. The trip line 310 may be employed in connection with bait 316 so that the animal will pull the trip line 310 away from the housing 302. Alternatively, the trip line 310 may instead be attached to a fixed object such as a tree so that an animal trips over the trip line 310, thus pulling the trip line away from the housing 302. In this employment, the trip line 310 may be set high enough so that small untargeted animals, such as field mice, can walk underneath the trip line 310 without touching the trip line 310. In either employment, the trip line 310 is configured to be pulled away from the housing 302 in order to activate a trigger mechanism 400 which in turn activates a retraction mechanism 500. The activation of the retraction mechanism 500 retracts the snare cable 307 into the housing 302 until the noose 308 is cinched tightly, as discussed in greater detail below.

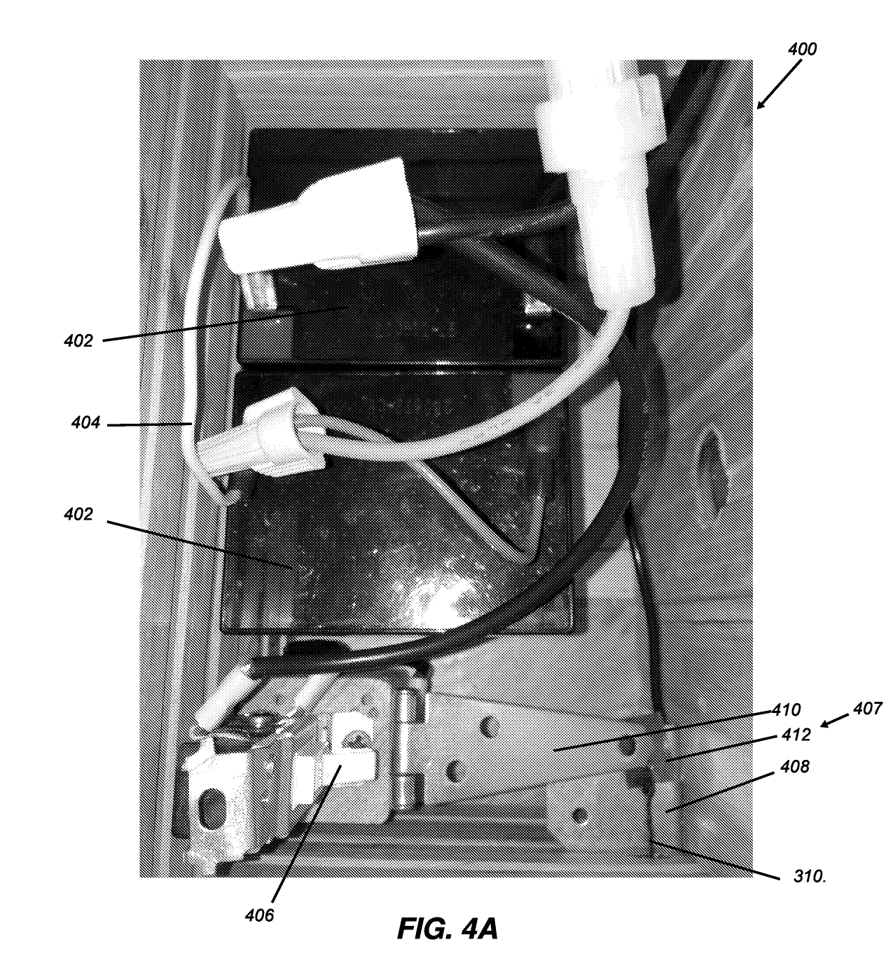

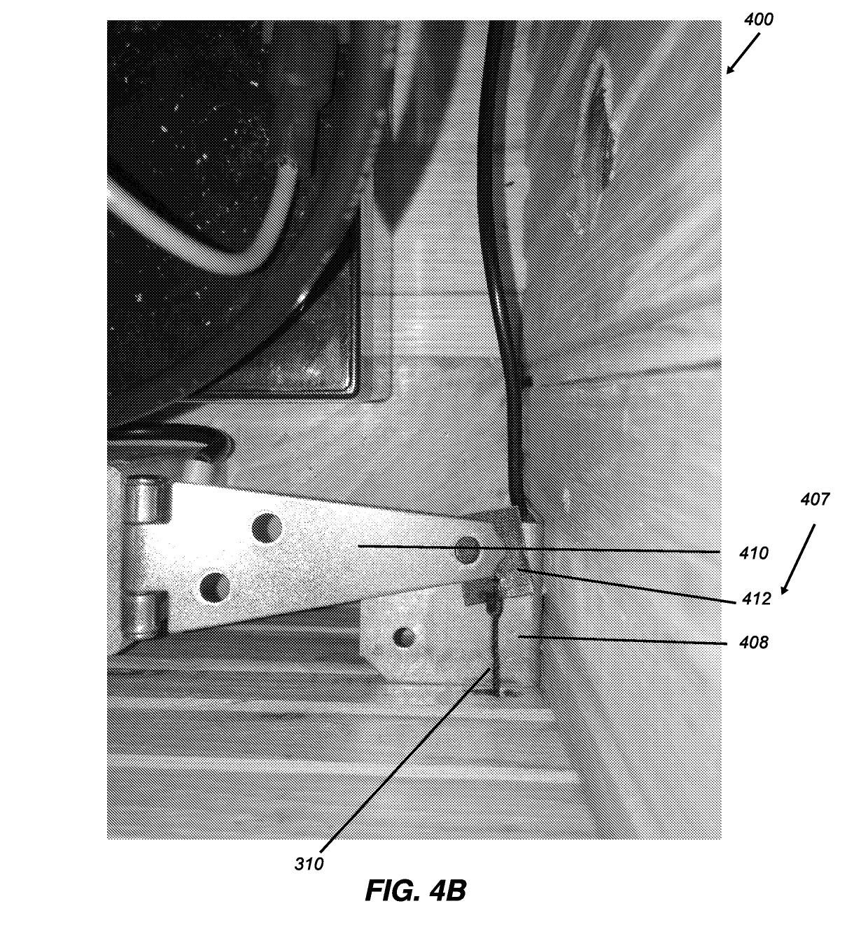

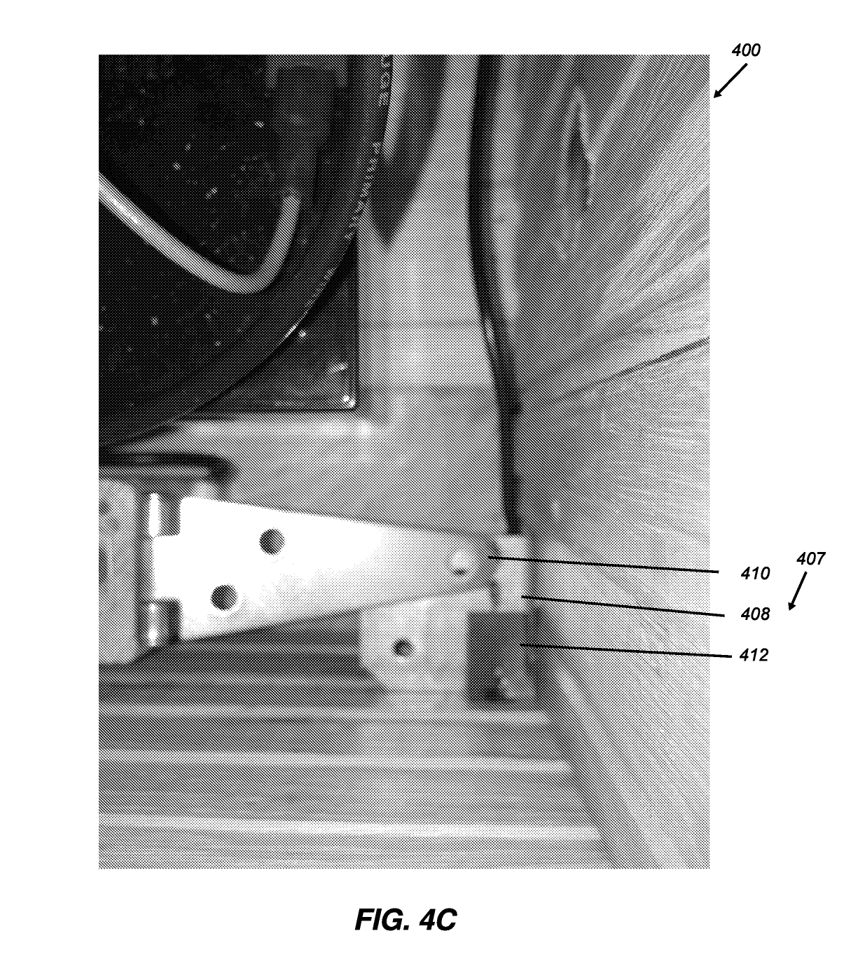

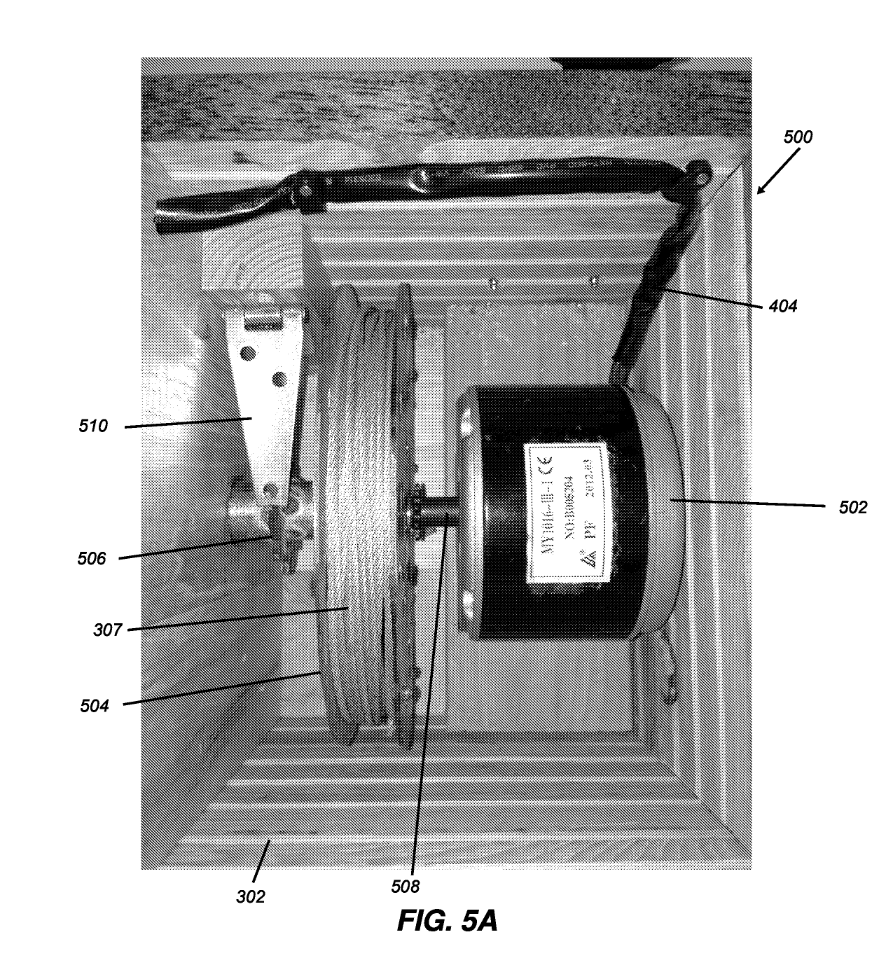

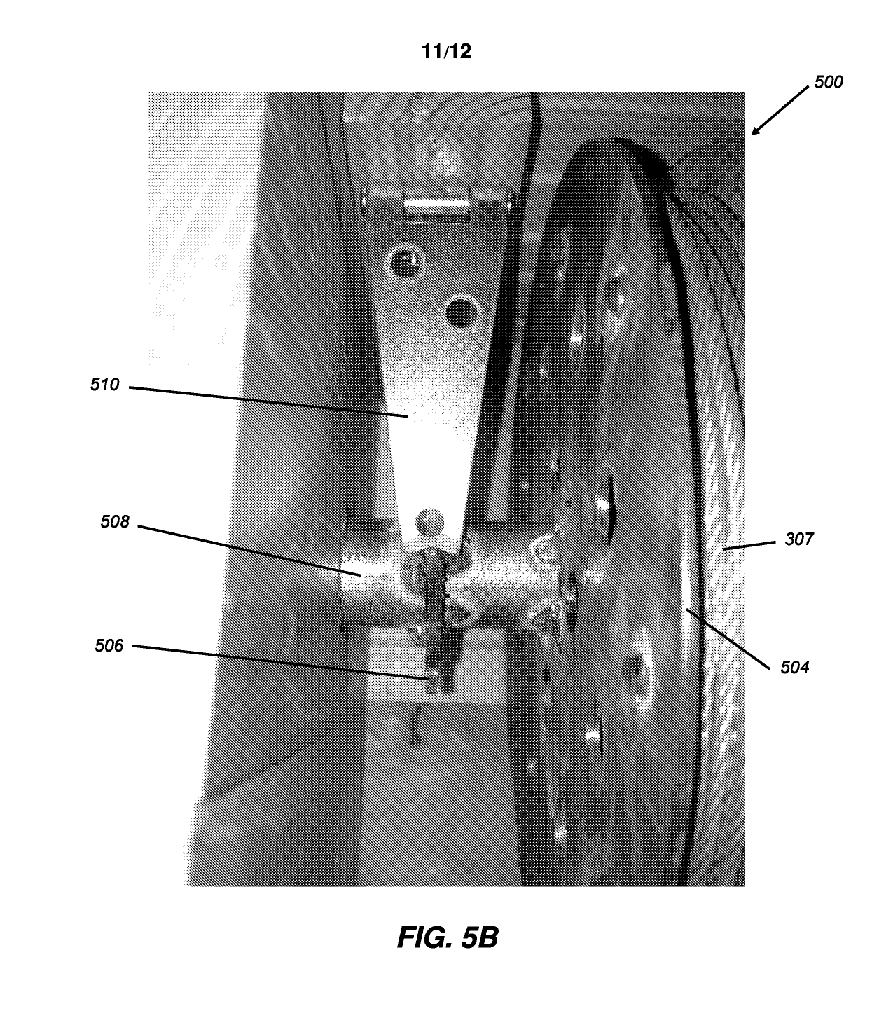

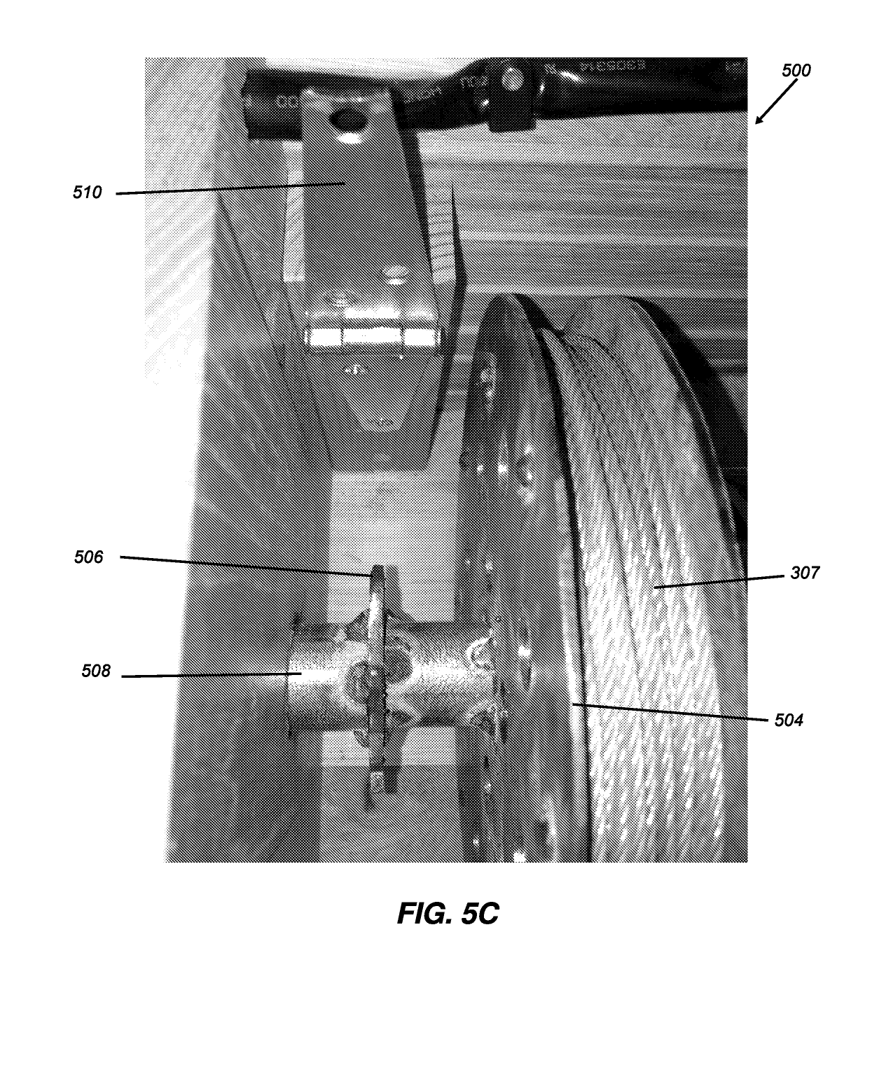

FIG. 4A is a top perspective view of the example trigger mechanism 400. The trigger mechanism 400 may include batteries 402, wiring 404, on/off switch 406, and a trigger switch 407. The trigger switch 407 may include a bottom plate 408, a top plate 410, and an insulator 412. The batteries 402 provide power to the trigger mechanism 400 and the retraction mechanism 500 (see FIGS. 5A-5C) via the wires 404. The batteries 402 may be wired in series to provide additional power. The batteries 402 may be 12 volt batteries, for example, such that when wired in series they output 24 volts. Additional batteries may be included, to increase the volts to 36 or 48 volts, for example, thus enabling the powering a larger and more powerful motor. The batteries 402 may also be rechargeable in order to allow the motorized snare 300 to be used indefinitely. For example, the batteries 402 may be connected to a solar recharging panel (not shown) such that the batteries can be recharged slowly over time and the motorized snare 300 will continue to function over a long period of time. The on/off switch 406 enables a trapper to turn the trigger mechanism 400 on or off. The motorized snare 300 may generally be set up while the on/off switch 406 is set to “OFF.” Then, once set up, the on/off switch 406 may be switched to “ON,” in which state the bottom plate 408 and the top plate 410 conduct electricity from the batteries 402 such that upon contacting one another, the circuit between the batteries 402 and the snare retraction mechanism 500 is complete, thus activating the motor 502 (see FIGS. 5A-5C).

As disclosed in FIG. 4B, when the on/off switch 406 is set to “ON,” the only thing preventing the top plate 410 from falling and contacting the bottom plate 408 is the insulator 412, which is attached to the trip line 310. However, as disclosed in FIG. 4C, when the trip line 310 is pulled, the isolator 412 is pulled out from underneath the top plate 410, which allows the top plate 410 to fall and contact the bottom plate 408, thus completing the circuit between the batteries 402 and the refraction mechanism 500 and thereby causing the motor 502 to be activated (see FIGS. 5A-5C).

FIG. 5A is a top perspective view of the example retraction mechanism 500. The refraction mechanism 500 may include a motor 502, a reel 504, a sprocket 506, a shaft 508, and an extraction lock 510. The motor 502 is power by the batteries 402 (see FIG. 4A) via the wires 404. The reel 504 and the sprocket 506 are attached to the motor 502 via the shaft 508. When the motor 502 is activated, the shaft 508 turns such that snare cable 307 is reeled into the housing 302 and onto the reel 504 until the noose 308 is cinched tight against the housing 302, at which point the motor 502 is configured to sense the inability to turn the shaft 508 further and shut off. This automatic shutting off of the motor 502 may be accomplished using a breaker that can be subsequently manually reset, for example.

As disclosed in FIG. 5B, the extraction lock 510 allows the shaft 508 to turn in the direction that allows the snare cable 307 to be reeled onto the reel 504, but engages with the sprocket 506 to prevent the shaft 508 from turning in the opposite direction, thereby preventing the snare cable 307 from unreeling from the reel 504. Thus, the extraction lock 510, when engaged, prevents an animal from unreeling the snare cable 307 from reel 504. However, as disclosed in FIG. 5C, when the extraction lock 510 is disengaged, the snare cable 307 can be unreeled from the reel 504, thus allowing an animal to be extracted from the noose 308, for example.

Unlike the prior art snares 100 and 200 of FIGS. 1 and 2, once the example motorized snare 300 of FIGS. 3A-5C has been transported to an appropriate location for trapping animals, the example motorized snare 300 can be easily secured to the ground and/or to a permanent object such as a tree. The motorized snare 300 can then be easily set up with the trigger mechanism 400 turned off, thus avoiding the snare loop 308 being retracted prematurely. In addition, due to the use of the electric motor 502, or other type of motor, with the electric trigger mechanism 400, or other electrical or mechanized trigger system, the motorized snare 300 can be activated more reliably and more quickly and with more force than the prior art snare 200 of FIG. 2, even where the animal is standing still. In addition, the relatively quick retraction of the noose 308 enables a larger noose to be set, and a noose that does not need to come in contact with the animal prior to the motorized snare 300 being triggered. A larger noose 308 can cover a larger area and decrease the risk that an animal will simply walk around the noose 308. In some embodiments, the noose 308 can itself be camouflaged, with local foliage for example, or even buried, further decreasing the risk that an animal will detect and avoid the noose 308. The size of the reel 504 can also enable a relatively long snare cable 307, which enables a variety of different configuration for the noose 308, including routing the noose 308 over an intermediate high point, such as a tree branch, to cause a trapped animal to be suspended in the air. In this and other configuration, it is understood that a stopper (not shown) can be placed at an intermediate point along the snare cable 307 so that the snare cable 307 is not retracted into the housing 302 to the point that the noose 308 is cinched against the housing 302, but is instead only partially refracted to a predetermined intermediate point before the motor 502 shuts off. Further, a long snare cable 307 allows the housing 302 and its internal mechanisms to be placed relatively remotely from the noose 308, thus remotely locating any human or other deterring smells that are associated with the housing 302 and its internal mechanisms. The motorized snare 300 can also be employed in environment without natural spring-loadable foliage, such as trees, and still be capable of automatically retracting the noose 308 around an animal.

Further, the batteries 402 provide a source of power to the vicinity of the motorized snare 300 such that other electricity-powered devices can be included in the motorized snare 300. For example, the batteries 402 enable the motorized snare 300 to additionally include a light (to enable a trapper to see the motorized snare 300 in the dark), a digital video camera (to take photographs or video of an passing animals), a microphone (to record sounds of animals), a motion detector (to trigger the light, the digital video camera, and/or microphone, for example), a radio transceiver or cellular phone transceiver (to automatically send a message wirelessly, such as an email, text, digital photograph, digital video clip, and/or audio message, for example, to a remotely located radio receiver of a trapper, such as a smart phone of the trapper, when the motorized snare 300 has captured an animal or has otherwise been activated), a speaker (to periodically or continually play sounds that will lure an animal), a heater (to warm the hands of the trapper), an electrocution device (to kill the animal upon being lured trapped by the motorized snare), an AM/FM radio (to entertain the trapper), an electric hot plate or stove (to cook the trapped animal), a locating beacon or GPS receiver (to help the trapper locate the motorized snare 300), a clock and/or stop watch (to track various measurements of time such as time between passing animals), an LCD display, or other electronic display including a 3D display and/or touchscreen display (to view photographs and pictures captured by the digital video camera or time measurements captured by the stopwatch, or any other digital output by the other electronic devices), a digital lock on the lid 304 of the housing 302, a digital thermometer (to alert the trapper to the ambient temperature), a remote control signal sensor (to allow a trapper to employ a handheld remote control to remotely trigger the motorized snare 300 or remotely disengage the extraction lock 510 to remotely release a trapped animal, for example), and an optical trigger system, such as an infrared trigger system (to use in place of or in addition to the trigger mechanism 400).

The example embodiments disclosed herein may be embodied in other specific forms. The example embodiments disclosed herein are to be considered in all respects only as illustrative and not restrictive.

What is claimed is:

1. A motorized snare comprising:
a housing;
a snare cable extending from the housing and terminating in a noose;
a retraction mechanism at least partially positioned within the housing and including a motorized reel attached to the snare cable; and
a trigger mechanism configured, upon being triggered, to cause the motorized reel to automatically reel in at least a portion of the snare cable into the housing.

2. The motorized snare as recited in claim 1, wherein the housing is a weatherproof housing.

3. The motorized snare as recited in claim 2, wherein the weatherproof housing includes a hinged lid that, when opened, allows access to a user to the interior of the housing.

4. The motorized snare as recited in claim 3, further comprising one or more latches configured, when latched, to prevent the hinged lid from opening.

5. The motorized snare as recited in claim 1, further comprising an anchoring mechanism attached to the housing and configured to anchor the housing to a fixed location.

6. The motorized snare as recited in claim 5, wherein at least a portion of the anchoring mechanism is configured to wrap around a tree trunk and be locked with a lock to securely anchor the housing to the tree trunk.

7. A motorized snare comprising:
a housing;
a snare cable extending from the housing and terminating in a noose;
a retraction mechanism at least partially positioned within the housing and including a motorized reel attached to the snare cable;
a trigger mechanism configured to cause the motorized reel to automatically reel in at least a portion of the snare cable into the housing; and
one or more batteries at least partially positioned within the housing and configured to provide power to the retraction mechanism and the trigger mechanism.

8. The motorized snare as recited in claim 7, further comprising a solar panel that is electrically connected to the one or more batteries and that is configured to recharge the battery.

9. The motorized snare as recited in claim 7, further comprising a digital video camera having a motion detector trigger and that is electrically connected to the one or more batteries.

10. The motorized snare as recited in claim 7, further comprising a radio transmitter or cellular phone transmitter that is electrically connected to the one or more batteries and that is configured to automatically send an electronic message wirelessly to a remotely located receiver that indicates that the motorized snare has captured an animal or has otherwise been activated.

11. The motorized snare as recited in claim 7, further comprising a locating beacon or GPS receiver that is electrically connected to the one or more batteries and that is configured to help a user locate the motorized snare.

12. The motorized snare as recited in claim 7, further comprising a remote control signal sensor that is electrically connected to the one or more batteries and that is configured to allow a user to employ a handheld remote control to remotely trigger the motorized snare or remotely disengage the motorized snare.

13. The motorized snare as recited in claim 7, wherein the trigger mechanism includes an optical trigger.

14. A motorized snare comprising:
a housing;
a snare cable extending from the housing and terminating in a noose;
a trip line extending from the housing;
a retraction mechanism at least partially positioned within the housing and including a motorized reel attached to the snare cable; and
a trigger mechanism at least partially positioned within the housing and configured to cause, upon pulling of the trip line, the motorized reel to automatically reel in at least a portion of the snare cable into the housing.

15. The motorized snare as recited in claim 14, wherein the noose includes a cinch locking mechanism configured to cause the noose to remain tightly cinched around a trapped animal even where the animal, the motorized snare, or both has ceased to exert any pressure against the noose.

16. The motorized snare as recited in claim 14, wherein the noose includes dampeners configured to dampen the force of the noose coming into contact with the housing when the snare cable is retracted into the housing.

17. The motorized snare as recited in claim 14, further comprising an extraction lock configured, when engaged, to prevent the snare cable from unreeling from the motorized reel and configured, when disengaged, to allow the snare cable to unreel from the motorized reel.

18. The motorized snare as recited in claim 14, further comprising an on/off switch configured, when set to off, to deactivate the trigger mechanism and configured, when set to on, to activate the trigger mechanism.

19. The motorized snare as recited in claim 14, further comprising a stopper positioned at an intermediate point along the snare cable and configured to prevent the snare cable from retracting into the housing past the position of the stopper.

20. The motorized snare as recited in claim 14, further comprising an anchoring mechanism attached to the housing and configured to anchor the housing to a fixed location.
